(19) United States
(12) Patent Application Publication
(10) Pub. No.: US 2014/0188479 A1
(43) Pub. Date: Jul. 3, 2014

(54) AUDIO EXPRESSION OF TEXT CHARACTERISTICS

(71) Applicant: INTERNATIONAL BUSINESS MACHINES CORPORATION, Armonk, NY (US)

(72) Inventors: Rachel K.E. Bellamy, Bedford, NY (US); Peter K. Malkin, Ardsley, NY (US); John T. Richards, Chappaqua, NY (US); Sharon M. Trewin, Croton-on-Hudson, NY (US)

(73) Assignee: INTERNATIONAL BUSINESS MACHINES CORPORATION, Armonk, NY (US)

(21) Appl. No.: 13/732,476

(22) Filed: Jan. 2, 2013

(51) Int. Cl. G10L 13/08

(52) U.S. Cl. CPC G10L 13/08
USPC 704/260

(57) ABSTRACT

In a method for communicating characteristics of an electronic document, a coefficient representative of predetermined characteristics of the electronic document is determined. The coefficient is associated with a corresponding audio rendering parameter. A speech signal communicating content of the electronic document is generated. The speech signal includes predetermined text content items audio formatted based on the audio rendering parameter. The speech signal is rendered to the user.

### TECHNICAL FIELD

The present invention relates generally to accessibility to electronic documents for visually impaired users and more specifically to expression of information about the document through audio formatting.

### BACKGROUND

The Internet has become an important communication tool. The phenomenal growth of Internet has made a wealth of information readily available to the general public. Much of the information comprises text documents. To facilitate visually impaired person's access to text documents the development of electronic aids has been ongoing for several decades. Blind and visually impaired computer users currently benefit from many forms of adaptive technology, including speech synthesis, large-print processing, braille desktop publishing, and voice recognition. However, when listening to synthesized speech, as opposed to reading it, the reader has limited awareness, if any, of important characteristics of the text, such as the overall length and complexity. Visually, a reader can get an impression by glancing over the text, seeing the overall length, and picking out complex words.

### SUMMARY

In one aspect, a method for communicating characteristics of an electronic document is provided. The method comprises determining a coefficient representative of predetermined quantifiable characteristics of an electronic document. The method further comprises associating the coefficient with a corresponding audio rendering parameter. The method further comprises generating a speech signal communicating content of the electronic document. The speech signal includes predetermined text content items audio formatted based on the audio rendering parameter. The method further comprises rendering the generated speech signal to a visually impaired user.

In another aspect, a computer program product for communicating characteristics of an electronic document is provided. The computer program product comprises one or more computer-readable tangible storage devices and a plurality of program instructions stored on at least one of the one or more computer-readable tangible storage devices. The plurality of program instructions comprises program instructions to determine a coefficient representative of predetermined quantifiable characteristics of an electronic document. The plurality of program instructions further comprises program instructions to associate the coefficient with a corresponding audio rendering parameter. The plurality of program instructions further comprises program instructions to generate a speech signal communicating content of the electronic document. The speech signal includes predetermined text content items audio formatted based on the audio rendering parameter. The plurality of program instructions further comprises program instructions to render the generated speech signal to a visually impaired user.

In yet another aspect, a computer system for communicating characteristics of an electronic document is provided. The computer system comprises one or more processors, one or more computer-readable tangible storage devices, and a plurality of program instructions stored on at least one of the one or more storage devices for execution by at least one of the one or more processors. The plurality of program instructions comprises program instructions to determine a coefficient representative of predetermined quantifiable characteristics of an electronic document. The plurality of program instructions further comprises program instructions to associate the coefficient with a corresponding audio rendering parameter. The plurality of program instructions further comprises program instructions to generate a speech signal communicating content of the electronic document. The speech signal includes predetermined text content items audio formatted based on the audio rendering parameter. The plurality of program instructions further comprises program instructions to render the generated speech signal to a visually impaired user.

### BRIEF DESCRIPTION OF THE SEVERAL VIEWS OF THE DRAWINGS

FIG. 1 is an illustration of a mobile device environment for auditory browsing of electronic documents in accordance with an embodiment of the present invention.

FIG. 2 is a diagram illustrating a web browser application accessing an electronic document in accordance with an embodiment of the present invention.

FIG. 3 illustrates steps performed by a document reader program for audio presentation of information rendered on the screen of the mobile device of FIG. 2.

### DETAILED DESCRIPTION

Embodiments of the present invention recognize that there are multiple screen reading tools, including software programs (e.g. the so called “talking browsers), available to blind and visually impaired persons enabling them to operate computers and/or mobile devices and to browse the internet in an auditory manner. It is to be noted that throughout the present document terms “blind” and “visually impaired” are interchangeably used. When a visually impaired user is directed to a document, it would be helpful for the user to know some information about the document in order to determine whether it is a document the user is interested in hearing. For example, existing screen reading tools provide summary info such as title, length, reading level, and the like. However, this information is provided audibly in sequential format, which adds a delay before the document is read.

The illustrative embodiments used to describe the invention generally address and solve the above-described problems and other problems related to accessibility to electronic documents for visually impaired users. Generally, an embodiment of the present invention provides the summary information indicative of one or more measurable characteristics associated with the electronic document that may be conveyed to the user simultaneously with rendering an audio version of the document. In one example, as the title of the electronic document is being read, if the reading level associated with the document is at a grade school level, the voice used to read the title might be formatted so that it is perceived as the voice of a grade school age person. Advantageously, by listening to the audio formatted text, the listener could obtain the desirable summary information. Thus, various embodiments facilitate user's awareness of the same summary information without any increase to the listening time.

Embodiments of the present invention will now be described with reference to the figures. Various embodiments of the present invention may be implemented generally within any computing device suited for allowing visually impaired users to browse electronic documents. More specifically, embodiments of the present invention may be implemented in a mobile computing device, i.e. a cellular phone, GSM (Global System for Mobile communications) phone, media player, personal digital assistant (PDA), and the like, which may enable a user to browse electronic documents in auditory manner. While some embodiments of the present invention are described with reference to an exemplary mobile computing device, it should be appreciated that such embodiments are exemplary and are not intended to imply any limitation with regard to the environments or platforms in which different embodiments may be implemented.

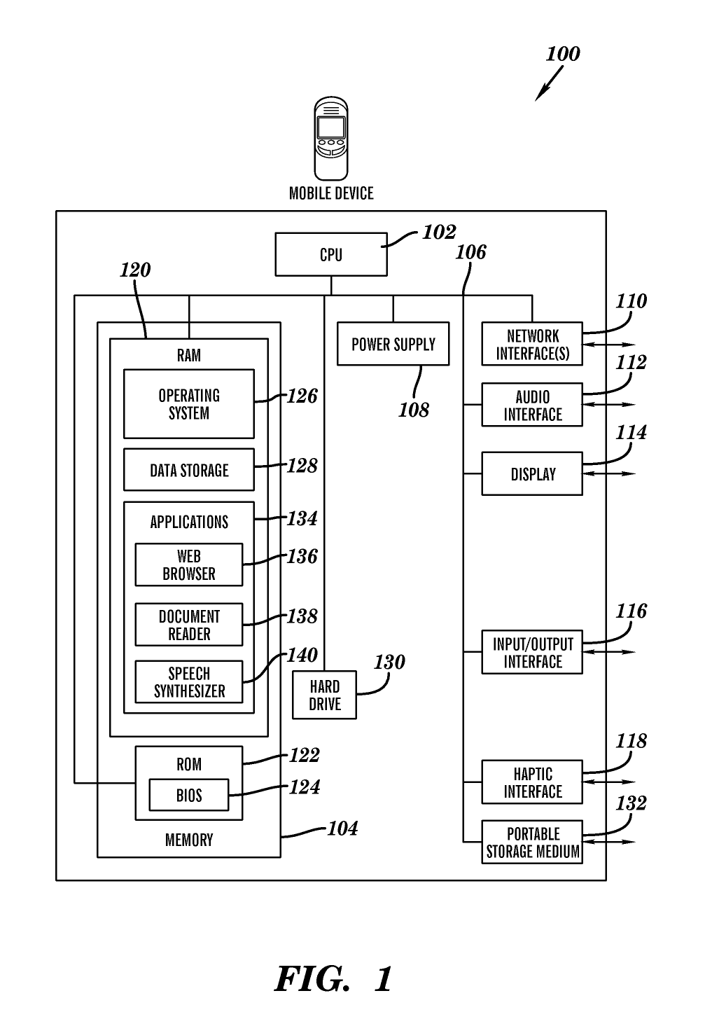

FIG. 1 is an illustration of a mobile device environment for auditory browsing of electronic documents in accordance with an embodiment of the present invention. Mobile device 100 may include many more or less components than those shown in FIG. 1. However, the components shown are sufficient to disclose an illustrative embodiment for practicing the present invention.

As shown in the figure, the client device 100 includes a processing unit (CPU) 102 in communication with a memory 104 via a bus 106. Mobile device 100 also includes a power supply 108, one or more network interfaces 110, an audio interface 112 that may be configured to receive an audio input as well as to provide an audio output, a display 114, an input/output interface 116, and a haptic interface 118. The power supply 108 provides power to the mobile device 100. A rechargeable or non-rechargeable battery may be used to provide power. The power may also be provided by an external power source, such as an AC adapter or a powered docking cradle that supplements and/or recharges a battery.

The network interface 110 includes circuitry for coupling the client device 100 to one or more networks, and is constructed for use with one or more communication protocols and technologies including, but not limited to, GSM, code division multiple access (CDMA), time division multiple access (TDMA), user datagram protocol (UDP), transmission control protocol/Internet protocol (TCP/IP), short message service (SMS), general packet radio service (GPRS), wireless application protocol (WAP), ultra wide band (UWB), IEEE 802.16 Worldwide Interoperability for Microwave Access (WiMax), session initiation protocol/real-time transport protocol (SIP/RTP), Bluetooth, Wi-Fi, ZigBee, universal mobile telecommunications system (UMTS), high-speed downlink packet access (HSDPA), wideband-CDMA (W-CDMA), or any of a variety of other wired and/or wireless communication protocols. The network interface 110 is also known as a transceiver, transceiving device, or network interface card (NIC).

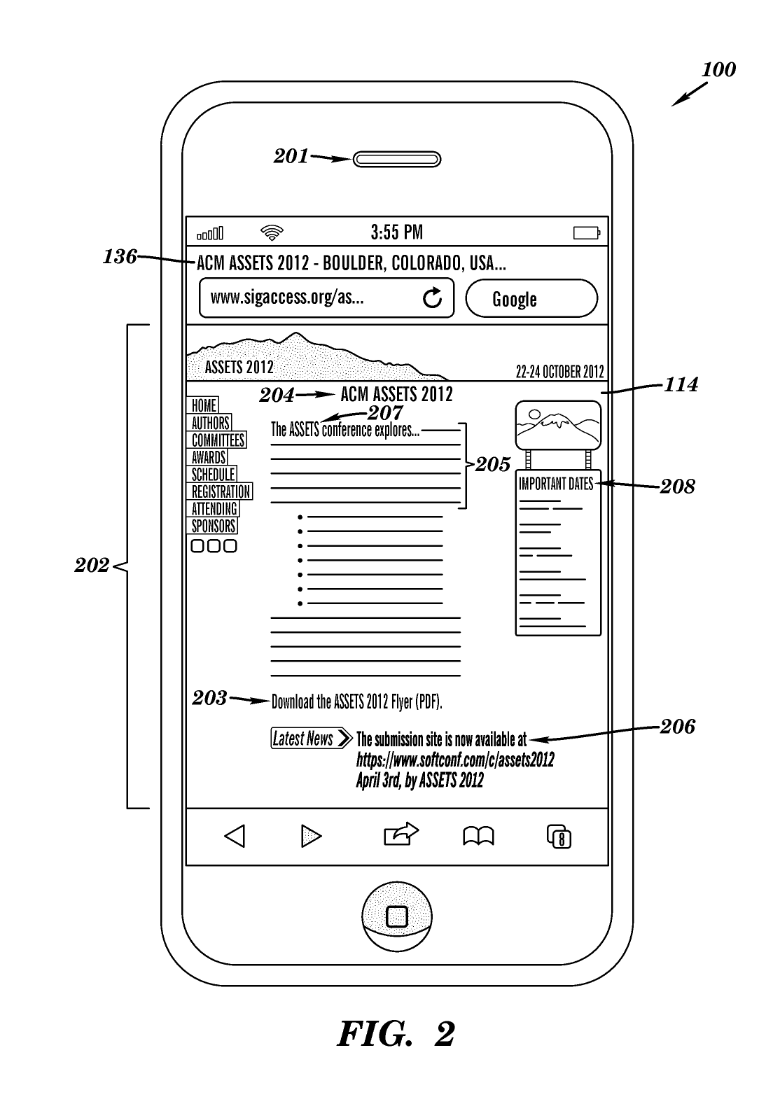

The audio interface 112 is arranged to produce and receive audio signals such as the sound of a human voice. For example, the audio interface 112 may be coupled to a speaker (shown in FIG. 2), and/or microphone (not shown) to enable telecommunication with others and/or render audio signals received from, for example, a document reader program 138. The display 114 may be a liquid crystal display (LCD), gas plasma, light emitting diode (LED), or any other type of display used with a mobile computing device. At least in some embodiments of the present invention, the display 114 may also include a touch sensitive screen arranged to receive input from an object such as a stylus or a human finger.

The mobile device 100 also includes the input/output interface 116 for communicating with external devices, such as a set of headphones (not shown), or other input or output devices not shown in FIG. 1. The input/output interface 116 can utilize one or more communication technologies, such as a universal serial bus (USB), infrared, Bluetooth®, or the like. The haptic interface 118 may be arranged to provide tactile feedback to a user of the mobile device 100. For example, the haptic interface 118 may be employed to vibrate the mobile device 100 in a particular way when, for example, another user of a mobile computing device is calling.

The memory 104 may include a RAM 120, a ROM 122, and other storage means. The memory 104 illustrates an example of computer-readable tangible storage media for storage of information such as computer readable instructions, data structures, program modules or other data. The memory 120 may also store a basic input/output system (BIOS) for controlling low-level operation of the mobile device 100. The memory 100 may also store an operating system 126 for controlling the operation of the mobile device 100. It will be appreciated that this component may include a general purpose operating system such as a version of UNIX, or LINUX®, or a specialized mobile communication operating system such as ANDROID®, Apple® iOS, BlackBerry® OS, and SYMBIAN OS®. The operating system 126 may include, or interface with a Java® virtual machine component that enables control of hardware components and/or operating system 126 operations via Java® application programs.

The memory 120 may further include one or more data storage units 128, which can be utilized by the mobile device 100 to store, among other things, applications and/or other data. For example, the data storage unit 128 may be employed to store information that describes various capabilities of the mobile device 100, a device identifier, and the like. The data storage unit 128 may also be used to store a plurality of user-configurable settings and preferences, as described below. In one embodiment, the data storage unit 128 may also store speech signal by the speech synthesizer program 140. In this manner, the mobile device 100 may maintain, at least for some period of time, speech signal that may then be rendered to a user by employing, for example, the audio interface 112. The data storage unit 128 may further include cookies, and/or user preferences including, but not limited to user interface options and the like. At least a portion of the speech signal, configurable user preferences information, and the like, may also be stored on an optional hard disk drive 130, optional portable storage medium 132, or other storage medium (not shown) within the mobile device 100.

Applications 134 may include computer executable instructions which, when executed by the mobile device 100, transmit, receive, and/or otherwise process messages (e.g., SMS, MMS, IMS, IM, email, and/or other messages), audio, video, and enable telecommunication with another computing device and/or with another user of another mobile device. Other examples of application programs include calendars, browsers, email clients, IM applications, VOIP applications, contact managers, task managers, database programs, word processing programs, security applications, spreadsheet programs, games, search programs, and so forth. Applications 134 may further include a web browser 136 and a document reader program 138 integrated with the speech synthesizer program 140.

The web browser 136 may include virtually any application for mobile devices configured to receive and render graphics, text, multimedia, and the like, employing virtually any web based language. In one embodiment, the web browser application 136 is enabled to employ Handheld Device Markup Language (HDML), Wireless Markup Language (WML), WMLScript, JavaScript, Standard Generalized Markup Language (SMGL), HyperText Markup Language (HTML), eXtensible Markup Language (XML), and the like, to render received information. However, any of a variety of other web based languages may also be employed.

The web browser 136 may be configured to enable a user to access a webpage and/or any other electronic document. The web browser 136 may be integrated with the document reader program 138, which may be configured to enable a visually impaired user to access the webpage and/or electronic document in an auditory manner.

Referring now to FIG. 2, a web browser application accessing an electronic document in a mobile device environment is illustrated. The exemplary mobile device 100 illustrated in FIG. 2 may include a relatively large display 114. In addition, the exemplary mobile device 100 may include a speaker 201 disposed within the housing of the mobile device 100. The speaker 201 may be employed to project audible sounds. The mobile device 100 may be capable of running relatively sophisticated applications, such as games, document processing applications, web browsers, and the like. The example illustrated in FIG. 2 depicts the mobile device 100 running the web browser 136. For illustrative purposes only assume that a visually impaired user has navigated to a particular web page 202 using the web browser 136. Typically, a web page contains visual information that is rendered by the web browser 136.

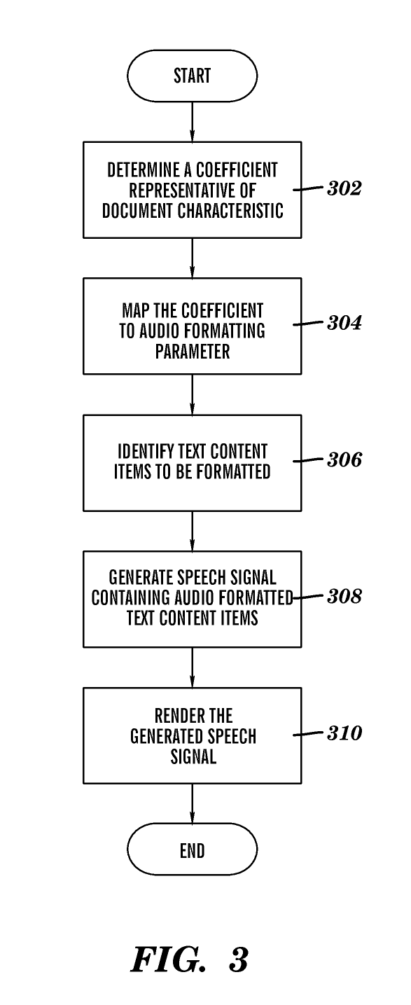

The electronic document (web page) 202, shown in FIG. 2, in addition to containing text content, such as, for example, a title 204, first paragraph 205, heading 208, may also contain links to other web page files. For example, a link 203 may read “Download the ASSETS 2012 Flyer (PDF)” and may allow the user to download the corresponding file in PDF format. Another link 206 may allow the user to navigate to a submission site. However, blind users cannot utilize the web page 202 rendered by the web browser 136, while visually impaired users may experience difficulty doing so. Accordingly, the mobile device 100 may be capable of running a document reader program 138 that may assist blind and visually impaired users to access information when they use the mobile device 100. Specifically, the document reader program 138 may be a screen reader program that cooperates with the web browser 136 and that reads aloud information appearing on the web page 202. The conventional screen reader program moves from element to element in a sequential manner. This is very limiting to an impaired user who may want, for example, to obtain an overview of some characteristics of the document, such as, for example, the overall length and complexity. Knowing these characteristics may help a user to decide whether to continue listening to the document or to move on to another task. Advantageously, according to an embodiment of the present invention, the document reader program 138 conveys one or more predefined quantifiable document characteristic to a user by mapping this one or more characteristic to a corresponding audio format and applying such format to a predefined document content element, as described below in conjunction with FIG. 3.

FIG. 3 illustrates steps performed by the document reader program 138 for audio presentation of information rendered on the screen of the mobile device of FIG. 2, according to an embodiment of the present invention. At 302, the document reader program 138 may calculate a coefficient representative of a predetermined document characteristic. Generally, users may be interested in various quantifiable characteristics of the accessed electronic document. The document characteristics of interest may include, for example, the length of the accessed document, the syntactic complexity, the reading difficulty of the text, and the like. In an embodiment of the present invention, visually impaired users may specify one or more characteristics they are interested about. The desired characteristics may be stored as user preferences, for example, in the data storage unit 128.

Once the desired quantifiable characteristics of the accessed electronic document are retrieved, the document reader program 138 may calculate one or more coefficient values corresponding to the obtained characteristics. The term “coefficient” is used herein to represent numeric values representative of document characteristics. For example, the document reader program 138 may determine a document length coefficient by counting the number of words contained in the document. Alternatively, the document length coefficient may be calculated by counting the number of characters contained in the document. In an embodiment of the present invention, users may specify a threshold, for example as a configurable user preference parameter, which may be used by the document reader program 138 to distinguish between long and short documents.

Similarly, the document reader program 138 may determine a syntactic complexity coefficient by, for example, identifying complexity of syntactic structures. In an embodiment of the present invention, well-known in the art software, such as, for example, but not limited to the Stanford Parser (an open-source parser software developed by Stanford University) may be utilized to identify complexity of syntactic structures. Syntactic structures may be expressed as “parse trees”, i.e. a hierarchical structure of constituents within a sentence. For example, the sentence “He gave the book to his little sister” would have three nominal constituents “he”, “the book”, and “his little sister” and a verbal constituent “gave”. Based on these syntactic structures, as exemplified above, the document reader program 138 may derive proficiency metrics (e.g., “frequency of nominal phrases per sentence”). Furthermore, the document reader program 138 may determine the syntactic complexity coefficient based on the proficiency metrics. For example, weights may be assigned to certain proficiency metrics. By combining those weights with calculated values for the proficiency metrics, an overall syntactic complexity coefficient for the electronic document 202 may be calculated. It should be noted that other methods of determining syntactic complexity coefficient may be utilized by the document reader program 138.

In an embodiment of the present invention, the document reader program 138 may also determine the reading difficulty coefficient associated with the electronic document 202 by, for example, utilizing well-known in the art formulas that measure readability of a text. Several different formulas are known to analyze text documents and rate the readability (e.g., the Flesch Reading Ease, Gunning Fog Index, and the Flesch-Kincaid Grade Level, among others).

The Flesch Reading Ease formula produces lower scores for text that is difficult to read and higher scores for text that is easy to read. The Flesch Reading Ease score is determined as follows:

FRE=206.835−(1.015*(ASL)+846*(NS); (1)

In the formula (1) FRE represents the Flesch Reading Ease score, ASL represents an average sentence length, and NS represents the number of syllables per 100 words. According to formula (1), a text scoring 90 to 100 is very easy to read and may be rated at the fourth grade level. A score between 60 and 70 may be considered standard and the corresponding electronic document would be readable by those having the reading skills of a seventh to eighth grader. A document generating a score between 0 and 30 may be considered very difficult to read.

The Gunning Fog Index also gives an approximate grade level a reader should have completed to understand the document using the following formula:

GFI=0.04*(ANWS+NW3S) (2)

In the formula (2) GFI represents the Gunning Fog Index, ANWS represents the average number of words per sentence, and NW3S represents the number of words of 3 syllables or more.

The Flesch-Kincaid Grade Level may be utilized using the following formula:

FKGL=0.39*ANWS+11.8*ANSPW−15.59 (3)

In the formula (3) FKGL represents the Flesch-Kincaid Grade Level, ANWS represents the average number of words per sentence and ANSPW represents the average number of syllables per word.

Furthermore, the document reader program 138 may determine the reading difficulty coefficient based on the combination of the formulas above. For example, in an embodiment of the present invention, weights may be assigned to results calculated using formulas (1), (2), and (3). By combining those weights with calculated values for the reading difficulty metrics, an overall reading difficulty coefficient for the electronic document 202 may be calculated. It should be noted that other methods of determining reading difficulty coefficient may be utilized by the document reader program 138.

Next, at 304, the document reader program 138 may associate one or more coefficients described above with one or more audio formatting parameters. In an embodiment of the present invention the document reader program 138 may employ a set of audio rendering rules. The audio rendering rules may be written in the audio formatting language (AFL) well-known in the art. According to an embodiment of the present invention, the audio rendering rules may manipulate a plurality of rendering parameters. In various embodiments of the present invention, the plurality of rendering parameters may include at least one of volume, gender of the speaker's voice, age of the speaker's voice, tone, pitch, speech speed, accent, and the like. It is contemplated that the document reader program 138 may take advantage of the high degree of control available via the AFL to create acoustical equivalents of visual formatting. The document reader program 138 may generate a mapping table containing a one-to-one mapping between the coefficients representative of document characteristics and rendering parameters. For example, a document length coefficient may be mapped to a specific pitch value.

As described below, the document reader program 138 may apply the plurality of rendering parameters to one or more text content items of the electronic document 202 to efficiently convey desirable information regarding the electronic document 202. In an embodiment of the present invention, the mapping table may be stored, for example, in the data storage unit 128 of the mobile computing device 100.

At 306, the document reader program 138 may identify a text content item that should be formatted to convey the document characteristics identified above. In an embodiment of the present invention, users may specify one or more text content item that could be used for such purpose. The desired text content items may be stored as user preferences, for example, in the data storage unit 128. A list of text content items that could be used for audio formatting may include, for example, but not limited to, the document title 204, first paragraph 205, first few words of the text 207, heading 208, and the like. The electronic document 202 may also contain links to other documents or web page files, such as the links 203 and 206 shown in FIG. 2. The visually impaired users may prefer to become aware of the document characteristics before, for example, downloading the document or visiting another web page. In this case, the users would specify in user preferences that, for example, HTML links contained within the electronic document should be used by the document reader program 138 to convey information about the corresponding documents.

It should be noted that different text content items may be used to convey different characteristics. For example, the document reader program 138 may audio format the document title 204 to convey the document length based on the document length coefficient, while the first paragraph 205 may be used for conveying the information about the document's reading difficulty based on the reading difficulty coefficient. In an embodiment of the present invention, the document reader program 138 retrieves a configurable user preference parameter stored in the data storage 138 to identify a text content item that should be formatted. Subsequently, the document reader program 138 may search the electronic document 202 for to-be-formatted text content items. In response to finding the content items of interest, the document reader program 138 may modify the electronic document 202 received from the web browser 136 to indicate which text content items require audio formatting.

In an embodiment of the present invention, if the electronic document 202 is an HTML document, the document reader program 138 may, for example, either modify an existing HTML tag or add a new HTML tag to indicate that corresponding HTML text content item requires audio formatting. The new HTML tag may also indicate a rendering parameter indicative of the document characteristic that should be associated with the corresponding text content item.

In an embodiment of the present invention, the document reader program 138 may be integrated with a speech synthesizer program 140. The speech synthesizer program 140 may be capable of converting the text contained in the electronic document 202 into speech. Methods of converting text to speech are well known in the art. According to an embodiment of the present invention, the speech synthesizer program 140 may convert the text data into a digital speech signal.

At 308, the document reader program 138 may send the modified electronic document to the speech synthesizer program 140 to generate a synthesized version of the accessed electronic document. In addition to the modified electronic text document, the document reader program 138 may also send the audio rendering rules (for example, written in the AFL), and/or rendering parameters that should be applied by the speech synthesizer program 138 to audio format one or more text content items marked by the document reader program 138 (at 306). In an embodiment of the present invention, the document reading program 138 may determine the required rendering parameters based on the mapping table created at 304. According to an embodiment of the present invention, in response to receiving the content of the document that needs to be converted along with the rendering parameters and/or rules, the speech synthesizer program 140 in the process of generating a synthesized version of the electronic document 202 may audio format marked text content items (for example, the text content items having a corresponding HTML tag) based on the rendering parameters specified by the document reader program 138.

For illustrative purposes only assume that the user's preference parameters indicate that child's voice should be applied to the first paragraph of the accessed document if the document has a low reading level. If, at 302, the document reader program 138 has determined that the overall reading difficulty coefficient of the electronic document 202 corresponds to a second grade difficulty level then, at 306, the document reader program 138 may insert an HTML tag (i.e., <param> tag) corresponding to the first paragraph that would define the rendering parameter. In other words, the inserted <param> tag would indicate to the speech synthesizer program 140 that first paragraph of the electronic document 202 should be read with a child's voice. Accordingly, the speech signal generated by the speech synthesizer program 140 may include one or more text content items (i.e., first paragraph 205) that would be rendered using child's voice when presented to the visually impaired user.

In an embodiment of the present invention, the speech synthesizer program 138 may send the synthesized version of the accessed electronic document 202 (the generated speech signal) back to the document reader program 138.

Subsequently to obtaining the speech signal from the speech synthesizer program 140, at 310, the document reader program 138 may be outputted to the speaker 201 via, for example, the audio interface 112. Alternatively, the generated speech signal may be rendered to a visually impaired user through the earplugs or headphones coupled to the mobile device 100.

Thus, the speech signal presented to the visually impaired user in accordance with embodiments of the present invention comprises a synthesized version of the accessed electronic document. The synthesized version may include an audio formatted portion corresponding to the user-specified content items that convey document characteristics of interest to the user. The formatted portion may help the visually impaired user to decide, for example, whether to continue listening to the synthesized version of the document. Advantageously, the document reader program 138 facilitates efficient presentation of the document properties/characteristics without increasing the listening time.

As will be appreciated by one skilled in the art, aspects of the present invention may be embodied as a system, method or computer program product. Accordingly, aspects of the present invention may take the form of an entirely hardware embodiment, an entirely software embodiment (including firmware, resident software, micro-code, etc.) or an embodiment combining software and hardware aspects that may all generally be referred to herein as a “circuit,” “module” or “system.” Furthermore, aspects of the present invention may take the form of a computer program product embodied in one or more computer readable medium(s) having computer readable program code embodied thereon.

Any combination of one or more computer readable medium(s) may be utilized. The computer readable medium may be a computer readable signal medium or a computer readable storage medium. A computer readable storage medium may be, for example, but not limited to, an electronic, magnetic, optical, electromagnetic, infrared, or semiconductor system, apparatus, or device, or any suitable combination of the foregoing. More specific examples (a non-exhaustive list) of the computer readable storage medium would include the following: an electrical connection having one or more wires, a portable computer diskette, a hard disk, a random access memory (RAM), a read-only memory (ROM), an erasable programmable read-only memory (EPROM or Flash memory), an optical fiber, a portable compact disc read-only memory (CD-ROM), an optical storage device, a magnetic storage device, or any suitable combination of the foregoing. In the context of this document, a computer readable storage medium may be any tangible medium that can contain, or store a program for use by or in connection with an instruction execution system, apparatus, or device.

A computer readable signal medium may include a propagated data signal with computer readable program code embodied therein, for example, in baseband or as part of a carrier wave. Such a propagated signal may take any of a variety of forms, including, but not limited to, electro-magnetic, optical, or any suitable combination thereof. A computer readable signal medium may be any computer readable medium that is not a computer readable storage medium and that can communicate, propagate, or transport a program for use by or in connection with an instruction execution system, apparatus, or device.

Program code embodied on a computer readable medium may be transmitted using any appropriate medium, including but not limited to wireless, wireline, optical fiber cable, RF, etc., or any suitable combination of the foregoing.

Computer program code for carrying out operations for aspects of the present invention may be written in any combination of one or more programming languages, including an object oriented programming language such as Java, Smalltalk, C++ or the like and conventional procedural programming languages, such as the “C” programming language or similar programming languages. The program code may execute entirely on the user's computing device, partly on the user's computing device, as a stand-alone software package, partly on the user's computing device and partly on a remote computing device or entirely on the remote computing device or server computer. In the latter scenario, the remote computing device may be connected to the user's computing device through any type of network, including a local area network (LAN) or a wide area network (WAN), or the connection may be made to an external computing device (for example, through the Internet using an Internet Service Provider).

Aspects of the present invention are described below with reference to flowchart illustrations and/or block diagrams of methods, apparatus (systems) and computer program products according to embodiments of the invention. It will be understood that each block of the flowchart illustrations and/or block diagrams, and combinations of blocks in the flowchart illustrations and/or block diagrams, can be implemented by computer program instructions. These computer program instructions may be provided to a processor of a general purpose computer, special purpose computer, mobile device or other programmable data processing apparatus to produce a machine, such that the instructions, which execute via the processor of the computing device or other programmable data processing apparatus, create means for implementing the functions/acts specified in the flowchart and/or block diagram block or blocks.

These computer program instructions may also be stored in a computer readable medium that can direct a computing device, other programmable data processing apparatus, or other devices to function in a particular manner, such that the instructions stored in the computer readable medium produce an article of manufacture including instructions which implement the function/act specified in the flowchart and/or block diagram block or blocks.

The computer program instructions may also be loaded onto a computing device, other programmable data processing apparatus, or other devices to cause a series of operational steps to be performed on the computing device, other programmable apparatus or other devices to produce a computer implemented process such that the instructions which execute on the computer or other programmable apparatus provide processes for implementing the functions/acts specified in the flowchart and/or block diagram block or blocks.

The flowchart and block diagrams in the Figures illustrate the architecture, functionality, and operation of possible implementations of systems, methods and computer program products according to various embodiments of the present invention. In this regard, each block in the flowchart or block diagrams may represent a module, segment, or portion of code, which comprises one or more executable instructions for implementing the specified logical function(s). It should also be noted that, in some alternative implementations, the functions noted in the block may occur out of the order noted in the figures. For example, two blocks shown in succession may, in fact, be executed substantially concurrently, or the blocks may sometimes be executed in the reverse order, depending upon the functionality involved. It will also be noted that each block of the block diagrams and/or flowchart illustration, and combinations of blocks in the block diagrams and/or flowchart illustration, can be implemented by special purpose hardware-based systems that perform the specified functions or acts, or combinations of special purpose hardware and computer instructions.

The description above has been presented for illustration purposes only. It is not intended to be an exhaustive description of the possible embodiments. One of ordinary skill in the art will understand that other combinations and embodiments are possible.

What is claimed is:

1. A method for communicating characteristics of an electronic document, the method comprising:
determining a coefficient representative of predetermined characteristics of an electronic document using a program embodied on a computer readable storage device communicating with a computing device, the computing device having a processor for executing the program;
associating the coefficient with a corresponding audio rendering parameter;
generating a speech signal communicating content of the electronic document, the speech signal including one or more predetermined text content items audio formatted based on the audio rendering parameter; and
rendering the speech signal to a user.

2. The method of claim 1, wherein the predetermined characteristics include at least one of a length, a syntactic complexity, and a reading difficulty of the text included in the electronic document.

3. The method of claim 1, wherein the audio rendering parameter includes at least one of volume, gender of the speaker's voice, age of the speaker's voice, tone, pitch, speech speed, accent.

4. The method of claim 1, wherein the one or more predetermined text content items include at least one of a title, a first paragraph of the text included in the electronic document, a sequence of words contained within the text included in the electronic document, a link included in the electronic document.

5. The method of claim 1, wherein the predetermined characteristics, the predetermined text content items, and the audio rendering parameter are stored as configurable user preferences.

6. The method of claim 1, wherein the coefficient representative of predetermined characteristics includes at least one of a document length coefficient, a syntactic complexity coefficient, a reading difficulty coefficient.

7. The method of claim 1, wherein the computing device comprises a mobile computing device.

8. A computer program product for communicating characteristics of an electronic document, the computer program product comprising one or more computer-readable tangible storage devices and a plurality of program instructions stored on at least one of the one or more computer-readable tangible storage devices, the plurality of program instructions comprising:
program instructions to determine a coefficient representative of predetermined characteristics of an electronic document;
program instructions to associate the coefficient with a corresponding audio rendering parameter;
program instructions to generate a speech signal communicating content of the electronic document, the speech signal including one or more predetermined text content items audio formatted based on the audio rendering parameter; and
program instructions to render the speech signal to a user.

9. The computer program product of claim 8, wherein the predetermined characteristics include at least one of a length, a syntactic complexity, and a reading difficulty of the text included in the electronic document.

10. The computer program product of claim 8, wherein the audio rendering parameter includes at least one of volume, gender of the speaker's voice, age of the speaker's voice, tone, pitch, speech speed, accent.

11. The computer program product of claim 8, wherein the one or more predetermined text content items include at least one of a title, a first paragraph of the text included in the electronic document, a sequence of words contained within the text included in the electronic document, a link included in the electronic document.

12. The computer program product of claim 8, wherein the predetermined characteristics, the one or more predetermined text content items, and the audio rendering parameter are stored as configurable user preferences.

13. The computer program product of claim 8, wherein the coefficient representative of predetermined characteristics includes at least one of a document length coefficient, a syntactic complexity coefficient, a reading difficulty coefficient.

14. The computer program product of claim 8, wherein the computing device comprises a mobile computing device.

15. A computer system for communicating characteristics of an electronic document, the computer system comprising one or more processors, one or more computer-readable tangible storage devices, and a plurality of program instructions stored on at least one of the one or more storage devices for execution by at least one of the one or more processors, the plurality of program instructions comprising:
program instructions to determine a coefficient representative of predetermined characteristics of an electronic document;
program instructions to associate the coefficient with a corresponding audio rendering parameter;
program instructions to generate a speech signal communicating content of the electronic document, the speech signal including one or more predetermined text content items audio formatted based on the audio rendering parameter; and
program instructions to render the speech signal to a user.

16. The computer system of claim 15, wherein the predetermined characteristics include at least one of a length, a syntactic complexity, and a reading difficulty of the text included in the electronic document.

17. The computer system of claim 15, wherein the audio rendering parameter includes at least one of volume, gender of the speaker's voice, age of the speaker's voice, tone, pitch, speech speed, accent.

18. The computer system of claim 15, wherein the one or more predetermined text content items include at least one of a title, a first paragraph of the text included in the electronic document, a sequence of words contained within the text included in the electronic document, a link included in the electronic document.

19. The computer system of claim 15, wherein the predetermined characteristics, the one or more predetermined text content items, and the audio rendering parameter are stored as configurable user preferences.

20. The computer system of claim 15, wherein the coefficient representative of predetermined characteristics includes at least one of a document length coefficient, a syntactic complexity coefficient, a reading difficulty coefficient.
